(19) United States
(12) Patent Application Publication
(10) Pub. No.: US 2006/0155491 A1
(43) Pub. Date: Jul. 13, 2006

(54) Frequency determination

(76) Inventor: Peter Bode, Nurnberg (DE)

Correspondence Address: PHILIPS INTELLECTUAL PROPERTY & STANDARDS, P.O. BOX 3001, BRIARCLIFF MANOR, NY, 10510, US

(21) Appl. No.: 10/563,925

(22) PCT Filed: Jul. 5, 2004
(86) PCT No.: PCT/IB04/51127

§ 371 Date: Jan. 9, 2006

(30) Foreign Application Priority Data
Jul. 11, 2003 (EP) 03102128.0

(51) Int. Cl. G06F 19/00

(52) U.S. Cl. 702/75

(57) ABSTRACT

Simple conventional frequency measurement circuits comprise two counters as essential elements. In such counters a problem may occur that the count value has a relative error of ±1/N, corresponding to the measurement interval. According to the present invention, pairs of intermediate count values of the counters are used to estimate the frequency ratio. According to an aspect of the present invention, this may be made on the basis of the steepness of a regression line determined on the basis of the pairs of intermediate count values of the counters. Furthermore, according to an aspect of the present invention, both counters continue counting while the intermediate sample values are sampled.

The present invention relates to the field of measuring or determining frequencies. In particular, the present invention relates to an electronic circuit for determining a ratio of a first frequency of a first signal and a second frequency of a second signal, to a method of determining a ratio of a first frequency of a first signal and a second frequency of a second signal and to a computer program product comprising computer program means.

Electronic circuits for frequency measurement are incorporated in a wide spectrum of electromechanical and electronic systems, such as for instance revolution controllers in CD/hard disc drives or interface circuits for the synchronization of electronic subsystems which are operated from independent clock oscillators.

A typical example for the latter are GSM mobile phones with GPS capability, comprising up to three independent crystal oscillators (XOs): A 26 MHz XO and a 32 kHz XO supply the GSM subsystem during active time and idle time, respectively, and a 20 MHz XO supplies the GPS subsystem. The 26 MHz XO is required as clean reference for the GSM RF synthesizers in GSM active mode, while the low power 32 kHz XO helps to reduce power consumption in GSM idle mode. In GSM idle mode, most of the GSM system including the 26 MHz XO are powered down. Merely the 32 kHz XO and a counter denoted as the 32 kHz ‘sleep counter’ is active. The sleep counter serves as a timer to power up the GSM system in time before a new paging message sent by the base station arrives. Due to typical tolerances of the 32 kHz XO, the GSM mobile phone is likely to miss part of the paging message. This is why GSM mobile phones include a frequency measurement unit which allows to estimate the ratio between the frequency of the 32 kHz XO and that of the 26 MHz XO. A similar need for frequency measurement arose recently with the advent of GPS capable GSM mobile phones. This is because GPS receiver ICs use traditionally another reference frequency than the magic 26 MHz of GSM and therefore need a dedicated GPS XO.

A crucial point for the application is the measurement latency which is governed by the accuracy requirements. It may be seen as a fundamental rule that the relative error decreases with increasing measurement interval. Conventional solutions lead to measurement intervals of a couple of seconds in both cases. It is a wide spread opinion that conventional circuits, which are based on counters, are optimum, leaving no room for improvement under the constraint of a simple digital hardware implementation. On the other hand, it is well known that the measurement interval can be reduced without compromising the accuracy if more sophisticated hardware were acceptable. One could for instance imagine the following approach: a) pass the digital clock through a filter removing the harmonics, b) digitize the resulting sinusoidal waveform with an ADC, c) apply some DSP algorithms for frequency estimation similar to algorithms which are used in the GSM receiver.

A measurement of a ratio of frequencies of two digital clock signal is usually made by means of relatively simple digital electronic circuits. These circuits normally comprise two counters triggered by the clock signals. For determining a ratio of both frequencies, a ratio of both count values after a certain measurement time is an indicator for the frequency ratio of the frequency of both clock signals.

The measurement time is typically selected such that it covers a plurality of cycles of the clock. The selection of the measurement time is usually made by means of a counter, such that a measurement window is defined. Thus, the change of this counter defining the measurement window is pre-set. Accordingly, only the change of the counter value of the respective other counter has to be sampled. Depending on the phases of both clock signals, the count value read from the counter may vary by one pulse or cycle. Thus, the measurement may have a maximum relative error of ±1/N, wherein N is the change of the count value read from the counter. The relative error may be reduced by selecting a long measurement time and thus a high N. However, for a wide range of applications such as mobile telecommunications (as described above), revolution or rotation speed controls for, for example, CD players, hard discs for computers or applications in car electronics or electrical measurement devices for laboratories or for manufacturing processes, accurate and fast frequency measurements become more and more desirable and are mandatory in some applications.

It is an object of the present invention to provide for a fast and accurate frequency measurement.

According to an exemplary embodiment of the present invention as set forth in claim 1, the above object may be solved by an electronic circuit as set forth in claim 1 for determining a ratio of a first frequency of a first signal and a second frequency of a second signal. The electronic circuit according to this exemplary embodiment of the present invention comprises a first counter, a second counter and a sampling means for sampling first intermediate count values of the first counter when the second counter reaches preset second intermediate count values such that the first counter is sampled under the control of the second counter. The first and second intermediate count values form a plurality of pairs of intermediate count values of the first and second counters. During the sampling of the first intermediate count values, the first and second counters continue counting. Furthermore, there is provided a calculation unit for determining the ratio of the first and second frequencies on the basis of the plurality of pairs of intermediate count values.

Advantageously, according to this exemplary embodiment of the present invention, intermediate count values are sampled while the counters keep running. Then, the ratio of the frequencies is estimated on the basis of these sampled intermediate count values. According to an aspect of this exemplary embodiment of the present invention, the resulting sequence of pairs of sampled intermediate count values may be shown as dots in a Cartesian coordinate system. Then, the intermediate count values, depending on the stability of the measured frequencies, would follow approximately a straight line. According to an aspect of the present invention, the steepness of the corresponding regression line may be determined and can be taken as an estimate of the wanted frequency ratio.

Advantageously, this may allow for a significant reduction of the measurement error, while keeping the measurement interval at the same length as, for example, compared to the conventional approach described above. According to an aspect of the present invention, it has been found that with a constant measurement window in comparison to the conventional approach described above, the measurement error may be reduced by a factor of 2 if 25 samples, i.e. pairs of intermediate count values of first and second counters are taken into consideration. In other words, an increase of the number of pairs of intermediate count values allows for a reduction of the measurement error.

An additional increase of the number of samples by a factor n, according to an aspect of the present invention, may cause an additional reduction of the measurement error by \sqrt{n}.

On the other hand, when the accuracy of the conventional approach is sufficient, the above described electronic circuit allows for a reduced measurement time, while yielding measurements with the same accuracy.

According to another exemplary embodiment of the present invention as set forth in claim 2, more than two pairs of sampled intermediate count values are used for the determination of the frequency ratio.

According to another exemplary embodiment of the present invention as set forth in claim 3, the first counter is triggered by one of a rising edge and a falling edge of the first signal, the second counter is triggered by one of a rising edge and a falling edge of the second signal, and a clock signal of the second counter is one of the first and second signals. The second intermediate count values of the second counter at which the first counter is sampled are preset in a register.

According to another exemplary embodiment of the present invention as set forth in claim 4, there is provided a memory comprising a first and a second storage. The first storage is for storing the first intermediate count values of the first counter such that a sequence of first intermediate count values of the first counter is provided and the second storage is for storing the second intermediate count values of the second counter such that a sequence of second intermediate count values of the second counter is provided.

Claims 5 and 6 provide for further exemplary, advantageous embodiments of the present invention.

According to another exemplary embodiment of the present invention as set forth in claim 7, there is provided a method of determining a ratio of a first frequency of a first signal and a second frequency of a second signal. According to an aspect of this exemplary embodiment of the present invention, a plurality of pairs of intermediate count values are sampled at the first counter under the control of the second counter, while the first and second counters continue counting. Then, on the basis of these pairs of intermediate count values, a ratio of the first and second frequencies is estimated.

Claim 8 provides for an exemplary embodiment of the method according to the present invention.

According to another exemplary embodiment of the present invention as set forth in claim 9, there is provided a computer program product comprising computer program code means. According to an aspect of this exemplary embodiment of the present invention, the computer program product may be a computer readable medium, such as a CD-ROM. The computer program code means relates to a computer program, which, when the computer program code means is executed on a processor, causes the processor to perform an operation corresponding to the method of the present invention. The computer program code means may be written in any suitable programming language, such as C++. Instead of being stored on a computer program product, the computer program code means, i.e. the computer program, may also be available from a network, such as the WorldWideWeb, from which it may be downloaded into the internal memory of a computer, processor or other suitable device.

Claim 10 provides for an exemplary embodiment of the computer program product according to the present invention.

It may be seen as the gist of an exemplary embodiment of the present invention, that pairs of intermediate counter values are sampled and stored while the counters keep running. Then, an estimate of the wanted frequency ratio is determined on the basis of pairs of these intermediate counter values. According to the present invention, it has been discovered that when the resulting sequence of pairs or intermediate counter values were shown as dots in Cartesian coordinates, they would follow approximately a straight line. According to an aspect of the present invention, the steepness of the corresponding regression line may be computed and this may be taken as an estimate of the wanted frequency ratio. Part of the electronic circuit according to the present invention may be operated in the clock domain, whereas another part of the circuit elements may be operated in the gating domain.

These and other aspects of the present invention will become apparent from and elucidated with reference to the embodiments described hereinafter.

Exemplary embodiments of the present invention will be described in the following, with reference to the following drawings:

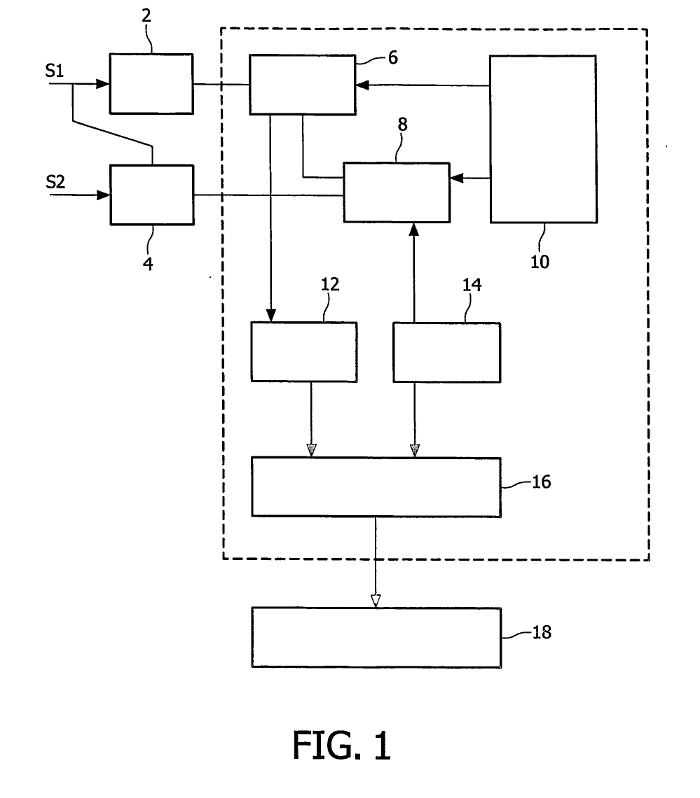

FIG. 1 shows a simplified circuit diagram of an exemplary embodiment of an electric circuit according to the present invention.

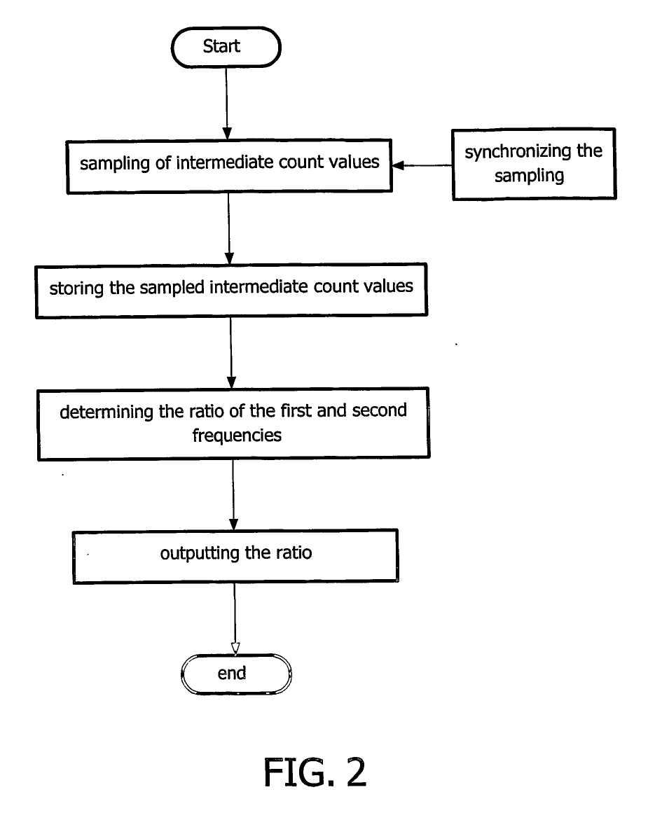

FIG. 2 is a flowchart of a method of operating the electronic circuit depicted in FIG. 1.

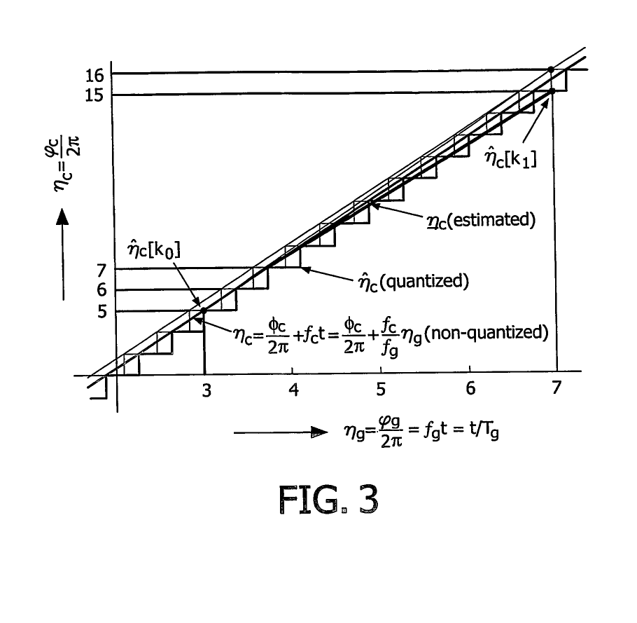

FIG. 3 is a diagram showing a normalized phase of a collecting clock, versus a normalized phase of a gating clock for further explaining the present invention.

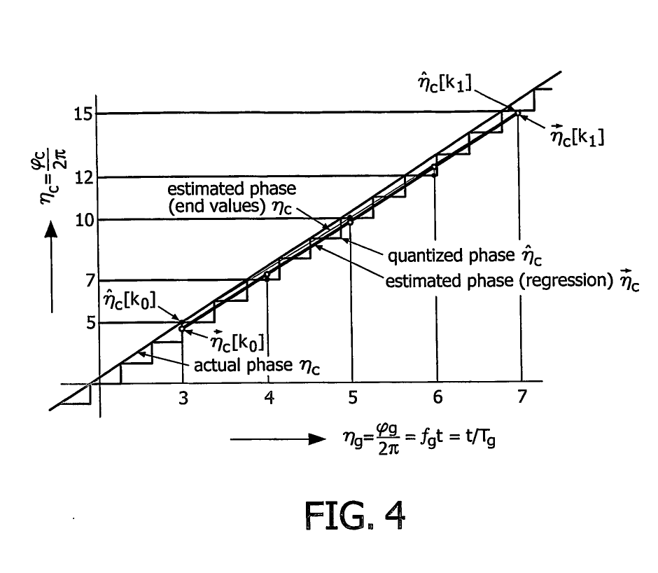

FIG. 4 is a diagram showing another normalized phase of a collecting clock, versus another normalized phase of a gating clock, according to an exemplary embodiment of the present invention.

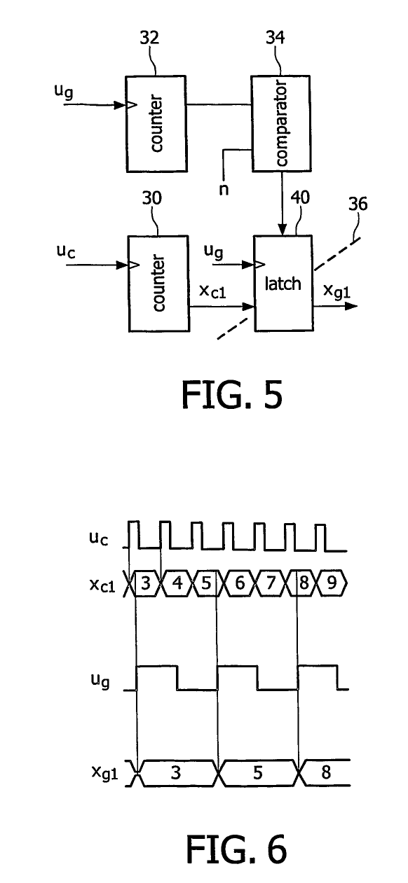

FIG. 5 shows a simplified circuit diagram of a second exemplary embodiment of the electronic circuit according to the present invention.

FIG. 6 shows timing charts of signals occurring in the electronic circuit of FIG. 5.

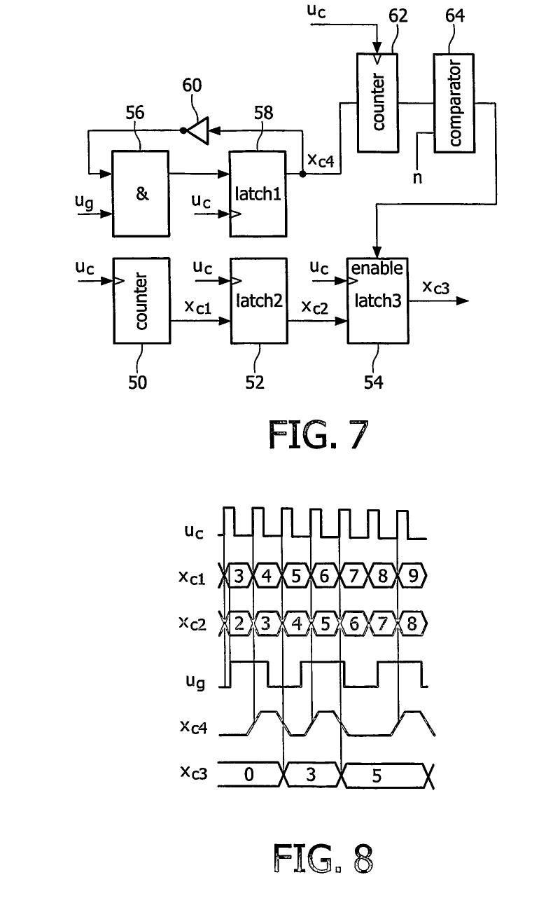

FIG. 7 shows a simplified circuit diagram of a third exemplary embodiment of the electronic circuit according to the present invention.

FIG. 8 shows timing charts of signals occurring in the electronic circuit of FIG. 7.

FIG. 1 shows a simplified circuit diagram of an exemplary embodiment of an electronic circuit for determining a ratio for first frequency f₁ of a first frequency of a first digital signal S₁ and a second frequency f₂ of a second digital signal S₂. As may be taken from FIG. 1, the first signal S₁ is input to a first counter 2 and the second signal S₂ is input to a second counter 4. The first counter 2 is triggered or incremented at each rising or falling edge of the first signal S₁.

As may also be taken from FIG. 1, the first signal S₁ is also input to the second counter 4, as clock signal. The second counter 4 is clocked by a rising or falling edge of the first signal S₁. Then, a count value of the counter 4 changes in accordance with a rising or falling edge of the second signal S₂.

Reference numeral 6 designates a first register connected to the first counter 2. The first register is arranged for storing an intermediate count value of the first counter during the counting of the first counter 2. In other words, while the first counter 2 continues counting, the first register 6 may sample intermediate count values of the first counter 2.

Furthermore, there is provided a second register 8, which is connected to the second counter 4. As may be taken from FIG. 1, the second register 8 is also connected to the first register 6. The second register 8 can be arranged such that at pre-set count values of the second counter 4, the second register 8 outputs a triggering signal to the first register 6. Then, when the first register 6 receives the triggering signal from the second register 8, the first register 6 samples an intermediate count value of the first counter 2. Accordingly, the second register 8 may define intermediate count values of the second counter 4, such that when the second counter 4 reaches those pre-set intermediate counter values, the second register 8 triggers the first register 6 such that the first register 6 samples intermediate count values of the first register 6.

Both the first register 6 and the second register 8 are connected to a synchronization unit 10. The synchronization unit 10 is adapted to control a period of time between the reaching of the pre-set count value by the second counter 4 and the sampling of first counter 2 by the register 6. In other words, the synchronization unit 10 controls a time relation between the reaching of the pre-set count value by the second counter 4 and the sampling of the intermediate count values of the first counter 2.

The first register 6 is connected to a first memory 12. The first memory 12 serves as an extension of the first register. Thus, during operation of the electronic circuit depicted in FIG. 1, a sequence of intermediate count values of the first counter 2 is stored in the first memory 12.

The counters 2 and 4 may be finite state machines (FSMs). Also, all elements contained in the dashed box, including the counters 2 and 4, may be implemented by means of FPGAs, PLDs, EPLDs, ASICs or adapted ICs.

There is second memory 14, which is connected to the second register 8. In the second memory 14, counter values or time points may be pre-set, at which the first counter 2 is to be sampled.

The first and the second memories 12 and 14 are connected to a calculation unit 16. The calculation unit is adapted to calculate on the basis of the sequences of count values of the first and second counters 2 and 4 stored in the first and second memories 12 and 14, an estimate of the ratio of the two frequencies S₁ and S₂. After determination of the frequency ratio, the calculation unit 16 outputs the determination or measurement result to an output unit 18.

The synchronization unit 10 and the calculation unit 16 may be realized by suitable hardware. They may also be realized by means of finite state machines (FSMs) or FPGAs, PLDs, EPLDs, ASICs or adapted ICs. However, as indicated by the gray line around the first and second registers 6 and 8, the synchronization unit 10, the first and second memories 12 and 14 and the calculation unit 16, these components may also be implemented by a suitable processor system. Then, the operation of the system is controlled by a suitable program. Such a program may be stored on a suitable machine readable medium, such as, for example, a CD-ROM. Such a program may be written in any suitable language, such as Assembler or C++. The registers 6 and 8 and the memories 12 and 14 may be implemented by the internal memory of the processor. A read access and a write access to such memory areas may be implemented by means of interrupt service routines.

The determination of the estimate of the ratio of the two frequencies f₁/f₂ is determined in the calculation unit 16, and may be described as follows:

The corresponding pairs of intermediate count values, i.e. the intermediate count values of the first and second counters 2 and 4 determined at corresponding time points, are indicated as points in a Cartesian coordinate system. Then, according to an aspect of the present invention, these points are along a straight line. A steepness of the corresponding regression line, according to an aspect of the present invention, is calculated, which corresponds to an estimate of the wanted frequency ratio. The straight line, according to an aspect of the present invention, is determined by means of a linear regression.

According to a variant of this exemplary embodiment of the present invention, the calculation unit 16 is adapted to calculate a modulation, i.e. a ratio of the two frequencies f₁/f₂, which varies over the time.

The task of a frequency measurement unit is to measure the frequency ratio of two independent digital clock signals which may be denoted as the gating clock and the collecting clock. The corresponding clock frequencies and clock periods may be denoted as f_{g}, f_{c}, T_{g}=1/f_{g} and T_{c}=1/f_{c}. As described above, simple conventional frequency measurement circuits comprise two counters as essential elements: The gating counter is clocked by the gating clock and the collecting counter is clocked by the collecting clock. The gating counter in combination with some comparator logic determines the measurement interval by enabling the collecting counter for a certain number of gating counter cycles N_{g}. The number of cycles the collecting counter collects during the measurement interval shall be denoted as N_{c}. The wanted frequency ratio f_{c}/f_{g} can be determined as follows:

Expressing the measurement interval in multiples of both T_{g} and T_{c} leads to the equation
N_{g}T_{g}=N_{c}T_{c}+dT_{c} (1)

where N_{g}T_{g} is the measurement interval in seconds and the term dT_{c} with −1<d<1 pays regard to the fact that the measurement interval may be not an integer multiple of T_{c} while the collecting counter can resolve only integer multiples of T_{c}. The nature of d will be addressed later. (1) may be written as:

$$\frac{{f}_{c}}{{f}_{g}} = \frac{{N}_{c}}{{N}_{g}} . ( 1 + \frac{d}{{N}_{c}} )$$

where the term ε=d/N_{c} represents the relative measurement error. To give an example, the worst case relative error for d=1 and N_{c}=26·10⁶ is ε=0.04·10⁻⁶. This reflects the situation of a typical GSM/GPS measurement with the measurement interval N_{c}T_{c}=1 sec and T_{c}=1/_{c}=1/f_{GSM}= 1/26 MHz.

In order to motivate the novel frequency measurement approach, further insight into the problem is needed. For this purpose, a normalized phase of a clock signal is introduced and it is shown that the current value of a counter represents a quantized version of it.

A square wave clock signal can be associated with φ(t), the phase of its Fourier fundamental tone. φ(t) is a linear ramp which is characterized by the initial phase φ and the frequency f:
φ(t)=2πft+φ.

Note that φ(t) is implicitly understood to be unwrapped throughout this note, meaning that it is not limited to the interval [0,2π].

Accordingly, there is a relation between the current value of a counter and the current value of the phase ramp of the clock signal. To make this relation more obvious, the quantized and normalized phase \hat{η} may be defined as

$$\hat{η} = [ \frac{φ}{2 π} ]$$

where [x] is the closest integer number equal to or less than x such that 0≦x−[x]<1 applies. The quantization causes the phase ramp to become step shaped and the normalization turns a 2 π interval into 1 cycle. Thus, a counter can be regarded to provide the quantized and normalized clock phase \hat{η}(t), assuming the triggering edge of the clock signal corresponds to the clock phase φ(t)=0 (modulo 2 π).

It is assumed that η_{g}=f_{g}t and η_{c}=φ_{c}/2π+f_{c}t for the non-quantized normalized phases of the gating clock and the collecting clock, respectively. It does not mean a loss of generality to assume φ_{g}=0 for the initial phase of the gating clock because the interesting phase relation between η_{g} and η_{c} is covered by φ_{c}. Note that η_{g} may be considered as normalized time η_{g}=t/T_{g} likewise because of f_{g}=1/T_{g}. Substitution yields

$${η}_{g} = \frac{{ϕ}_{c}}{2 π} + \frac{{f}_{c}}{{f}_{g}} {η}_{g} .$$

FIG. 3 shows, an example of η_{c}(η_{g}) and its quantized version \hat{η}_{c}.

FIG. 3 shows the normalized phase of the collecting clock versus the normalized phase of the gating clock. The current value of the collecting counter can be regarded as representing \hat{η}_{c}. Conventional frequency measurement circuits rely on two samples \hat{η}_{c}[k₀] and \hat{η}_{c}[k₁] from the collecting counter. The dashed curves illustrate the impact of φ_{c}, the constant phase offset of η_{c}: In case of the black curves, φ_{c} was chosen such that any further reduction of φ_{c} would cause \hat{η}_{c}[k₀] to change from 5 to 4. In case of the dashed curves, φ_{c} was chosen such that any further reduction of φ_{c} would cause \hat{η}_{c}[k₁] to change from 16 to 15. Note that a \hat{η}_{c}[k₀]=5 applies in both cases.

Therefore, frequency measurement turns into the problem of estimating the steepness of the phase ramp η_{c}(η_{g}). If there were access to the non-quantized normalized phases, an exact solution would be

$$\frac{{f}_{c}}{{f}_{g}} ≅ \frac{η [ {k}_{1} ] - {η}_{c} [ {k}_{0} ]}{{k}_{1} - {k}_{0}} .$$

where k₀=η_{g}(t₀) and k₁=η_{g}(t₁) could be chosen arbitrarily. According to the present invention, an approximation is made.

A straightforward approach is the conventional method in which samples \hat{η}_{c}[k₀] and \hat{η}_{c}[k₁] are taken from the collecting counter as an approximation of η_{c}[k₀] and η_{c}[k₁]. Here, k₀ and k₁ are the first and the last value of the gating counter spanning the measurement interval and \hat{η}_{c}[k] is the value of the collecting counter at the beginning of the k-th gating clock period. It may be sufficient to assume that \hat{η}_{c}[k] can be obtained by sampling the current value of the collecting counter with the rising edge of the gating clock. The points \hat{η}c[k₀] and \hat{η}[k₁] define the connecting line η_{c} which can be regarded as an approximation of η_{c}. Thus, the frequency ratio can be estimated as

$$\frac{{f}_{c}}{{f}_{g}} ≅ \frac{{\hat{η}}_{c} [ {k}_{1} ] - {\hat{η}}_{c} [ {k}_{0} ]}{{k}_{1} - {k}_{0}} = \frac{{N}_{c}}{{N}_{g}} .$$

FIG. 3 depicts \hat{η}_{c}[k₀]and \hat{η}_{c}[k₁] for the choice k₀=3 and k₁=7. The black curves and the dashed curves illustrate how the initial phase φ_{c} of η_{c}(t)=φ_{c}/2π+f_{c}t, affects the steepness of the estimate η_{c}(t). Depending on φ_{c}, N_{c} takes the values 15−5=10 or 16−5=11 with the consequence that the estimate of the frequency ratio f_{c}/f_{g} is too small or too big. It is a general rule applying for any frequency ratio f_{c}/f_{g} that N_{c} can take no more than two values and that the value which is taken depends on the phase relation between the collecting block and the gating clock.

The previous discussion presented the frequency estimation problem as the task of estimating the steepness of the non-quantized phase ramp η_{c}(k) of the collecting clock based on observations of its quantized version η_{c}[k]. Having this picture in mind, the conventional method appears sub-optimal because it makes use of only two samples from \hat{η}_{c}[k] while information from within the measurement interval is ignored: Given a measurement interval lasting N_{g}=k₁−k₀ gating clock cycles, one could take a total of N_{g}+1 samples from the collecting counter with every rising edge of the gating clock.

These samples \hat{η}_{c}[k] are marked as black dots in FIG. 5. They are spread around the black regression line \vec{η}_{c}. Samples \vec{η}_{c}[k] from the regression line are marked by hollow dots. According to the present invention, in terms of steepness, \vec{η}_{c} looks like a better estimate of η_{c} than η_{c}.

For practical reasons, it may be desirable to consider a subset from the N_{g}+1 samples of \hat{η}_{c}[k]. For instance, if N_{g} is in the order of 10⁶, it may be not desirable to compute the regression line on the basis of such a large number of samples. As set forth above, k represents the integer values from the continuous normalized phase of the gating clock η_{g}. A subset from these integer values shall be denoted as
η_{g}[m]
where m is the index within the subset of size M with 0≦m<M.

An example for a subset is the equidistant grid
η_{g}[m]=m·[N_{g}/M]
where the integer number [N_{g}/M] is the grid spacing.

Another example for a subset is the uniformly jittered grid
η_{g}[m]=m·[N_{g}/M]+rnd[m].

Here, rdn[m] is a uniformly distributed integer random variable in the range R₀≦rnd[m]≦R₁ where R₀ and R₁ are integers. The simulation results show that a jittered grid can be beneficial for certain constellations.

Given the samples \hat{n}_{c}[η_{g}[m]] for some subset η_{g}[m], the regression line can be determined as follows: The following hypothesis is assumed:
\vec{η}_{c}[η_{g}[m]]=a₀+a₁η_{g}[m].

The constant normalized phase offset a₀ and the steepness a₁ are to be chosen such that the energy E of the error signal \hat{η}_{c}[η_{g}[m]]−\vec{η}_{c}[η_{g}[m]] becomes minimum. The unknowns a₀ and a₁ are found by solving the equations

$$\begin{matrix}\frac{\partial }{\partial {a}_{0}} E ( {a}_{0} , {a}_{1} ) = \frac{\partial }{\partial {a}_{0}} {\sum }_{m} {( {\hat{η}}_{c} [ {η}_{g} [ m ] ] - {a}_{0} - {a}_{1} {η}_{g} [ m ] )}^{2} = 0 & ( 3 ) \\ \frac{\partial }{\partial {a}_{1}} E ( {a}_{0} , {a}_{1} ) ≅ \frac{\partial }{\partial {a}_{1}} {\sum }_{m} {( {\hat{η}}_{c} [ {η}_{g} [ m ] ] - {a}_{0} - {a}_{1} {η}_{g} [ m ] )}^{2} = 0 & ( 4 )\end{matrix}$$

This leads to the linear equation system

$$[ \begin{matrix}{B}_{1} \\ {B}_{2}\end{matrix} ] = [ \begin{matrix}{A}_{11} & {A}_{12} \\ {A}_{21} & {A}_{22}\end{matrix} ] \cdot [ \begin{matrix}{a}_{0} \\ {a}_{1}\end{matrix} ] \qquad ( 5 )$$

with the data dependent coefficients

$$\begin{matrix}{B}_{1} = {\sum }_{m} {\hat{η}}_{c} [ {η}_{g} [ m ] ] & ( 6 ) \\ {B}_{2} = {\sum }_{m} {\hat{η}}_{c} [ {η}_{g} [ m ] ] \cdot {η}_{g} [ m ] & ( 7 )\end{matrix}$$

and the data independent coefficients

$$\begin{matrix}{A}_{11} = M & ( 8 ) \\ {A}_{12} = {A}_{21} = {\sum }_{m} {η}_{g} [ m ] \\ {A}_{22} = {\sum }_{m} {( {η}_{g} [ m ] )}^{2} . & ( 9 )\end{matrix}$$

The unknowns a₀ and a₁ follow by first computing (6) to (10) and then solving (5).

Because the coefficients A₁₁, A₁₂, A₂₁ and A₂₂ are independent from the (data) samples \hat{η}_{c}, it is sufficient to compute them once, after some appropriate values M and η_{g}[m] have been chosen. Merely B₁ and B₂ are data dependent and need to be computed anew for a fresh set of samples η_{g}[m].

The computational load is proportional to the number of samples M if M is large and hence the effort for computing B₁ and B₂ dominates the effort for solving the equation system (5).

Because the unknown constant phase a₀ is of no interest, it is not required to compute it explicitly.

Early frequency estimates with reduced accuracy can be obtained by computing a₁ for the first M₀<M samples. As further samples arrive, updates of a₁ can be computed with reduced effort, due to the cumulative nature of (6) to (10).

Because of the simple nature of the equation system (5), it is possible to quote the solution a₁ explicitly. It turns out that this explicit solution can be understood to be closely related to a single output sample of a Finite Impulse Response (FIR) filter. (This filter has a ramp shaped impulse response and can be regarded as a matched filter as known from communication theory.) Thus some appropriate FIR filter implementation may be chosen.

If the frequency ratio to measure changes with time, one may wish to measure it repeatedly. Depending on the update rate, the new set of M samples may or may not overlap with the previous set of samples. If there is overlap, some reduction of the computational load may be possible.

The frequency ratio may be known to change during the measurement interval in which the M samples are taken. This could be for instance due to asymptotic exponential settling of one of the two frequencies after switching on the respective crystal oscillator. In this case one could estimate the parameters of a more sophisticated regression curve.

FIG. 5 shows a simplified circuit diagram of a second exemplary embodiment of the electronic circuit according to the present invention which operates in accordance with the above described principle according to an aspect of the present invention.

As may be taken from FIG. 5, there is provided a counter 30 and a latch 40. As may also be taken from FIG. 5, the signal u_{c} is input into the clock input of the counter 30. Then, the output signal x_{c1} is output to the latch 40, the clock input of which receives the signal u_{g}. The output signal of the latch 40 is the signal x_{g1}.

Furthermore, there is provided a counter 32 and a comparator 34. The clock input of the counter 32 receives the gating clock signal u_{g}. The output signal of the counter 32 is input to the comparator 34, which, each time the count value output by the counter 32 reaches n, outputs an enable signal to the latch 40.

The gray line 36 indicates the clock domain transition, i.e. the border between elements of the circuitry operated by the collecting clock u_{c} and the gating clock u_{g}.

FIG. 6 shows timing charts of the respective signals occurring in the electronic circuit of FIG. 5. As may be taken from FIG. 6, there may be a problem occurring in the electronic circuit depicted in FIG. 5 in case there are ideal conditions. However, a problem may occur due to the fact that the bits of the counter output signal x_{c1} do not change exactly synchronously. Hence, the output signal of the latch 40, namely the signal x_{g1} may, in some instances, be wrong if the sampling edge of the gating clock u_{c} occurs while the counter bits are changing.

FIG. 7 shows a simplified circuit diagram of a third exemplary embodiment of the electronic circuit according to the present invention. With this electronic circuit according to this third exemplary embodiment of the present invention, the synchronism issue described with reference to FIGS. 5 and 6 may be avoided.

As may be taken from FIG. 7, the signal u_{c} is input into the clock port of a counter 50, the output signal of which, x_{c1}, is input into a latch2 52. The clock input of the latch2 52 also receives the signal u_{c}. The output signal of the latch2 52 x_{c2} is output to a latch3 54, the clock input of which is also connected to the signal u_{c}.

The input signal u_{g} is input into one input of an AND gate 56, the output of which is input to a latch1 58. The clock port of the latch1 58 is also connected to the input signal u_{c}. The output signal of the latch1 58 x_{c4} is sent back via an inverter 60 to the other input of the AND gate 56. Furthermore, the signal x_{c4} is input into the enable port of another counter 62, which is clocked by the collecting clock u_{c}. The count signal of the counter 62 is output to a comparator 64, where the count signal is compared to the comparison value n, such that each time a count value of the counter signal 62 reaches n, the comparator 64 outputs an output signal, which is input as an able signal into latch3 54. The clock domain transition is located at the latch1 58.

FIG. 8 shows timing charts of signals occurring in the electronic circuit depicted in FIG. 7. The first timing chart of FIG. 8 sketches the signal u_{c} over the time. The second timing chart sketches the signal x_{c1} over the time. The third timing chart sketches the signal x_{c2} over the time. The fourth timing chart sketches the signal u_{g} over the time. The fifth timing chart sketches the signal x_{c4} over the time and the sixth timing chart sketches the signal x_{c3} over the time.

As may be taken from FIG. 8, the synchronism problems, which may occur in the circuit depicted in FIG. 5, may be avoided with the electronic circuit depicted in FIG. 7, in which the gating clock u_{g} is sampled by the collecting clock u_{c} and all further processing occurs in the domain of the collecting clock. The “gating clock detect” signal x_{c4} plays the key role in this electronic circuit. If a rising edge occurs in the gating clock signal u_{g} during the n collecting clock circle, this causes x_{c4} to go high during the collecting clock cycle n+1 and to go low again in cycle n+2. Due to this, x_{c4} may be used to enable latch3 54 to take over x_{c2}, which is a delayed version of x_{c1}.

However, it has to be noted that the electronic circuits depicted in FIGS. 5 and 7 are equivalent in the sense that either of the signals x_{g1} and x_{c3} represent samples from the collecting counter, cycling through the same sequence of counter values. This is because a) sampling the collecting clock under x_{c1} some time during the n-th collecting clock cycle with the rising edge of the gating clock u_{g} is the same as b) detecting a rising edge of the gating clock u_{g} some time during the n-th collecting clock cycle and looking up the number of the clock cycles later.

According to variants of these exemplary embodiment of the present invention, in order to define a sub-set of all possible samples (sampling grid), the circuitry may be extended by a comparator and a register holding kₘ=η_{g}[m], the number of the gating clock cycle, which shall trigger the sampling. Once the trigger condition occurs and the sample is available, the sample must be stored away and the next trigger instant must be loaded. Storing and loading can be to and from FIFOs or to and from processor memories under the control of an interrupt service routine.

Advantageously, according to the present invention, there is a significant reduction of the measurement error, while not extending the measurement interval. Likewise, the measurement interval may be reduced by keeping the same measurement error as in the conventional approaches known in the art. Simulations for a typical application show a reduction of the measurement error by a factor of 2, if 25 samples are available. An additional increase of the number of samples by a factor n causes an additional reduction of the measurement error by \sqrt{n}.

1. Electronic circuit for determining a ratio of a first frequency of a first signal and a second frequency of a second signal, the electronic circuit comprising:—a first counter and a second counter;—a sampling means for sampling first intermediate count values of the first counter when the second counter reaches preset second intermediate count values such that the first counter is sampled under the control of the second counter;—wherein the first and second intermediate count values form a plurality of pairs of intermediate count values of the first and second counters;—wherein, during the sampling of the first intermediate count values, the first and second counters continue counting; and—a calculation unit for determining the ratio of the first and second frequencies on the basis of the plurality of pairs of intermediate count values.

2. The electronic circuit of claim 1,—wherein more than two pairs of intermediate count values are used by the calculation unit for determining the ratio of the first and second frequencies.

3. The electronic circuit of claim 2,—wherein the first counter is triggered by one of a rising edge and a falling edge of the first signal;—wherein the second counter is triggered by one of a rising edge and a falling edge of the second signal;—wherein a clock signal of the second counter is one of the first and second signals;—wherein the second intermediate count values of the second counter at which the first counter is sampled are preset in a register.

4. The electronic circuit according to claim 2, further comprising:—a memory;—wherein the memory comprises a first and a second storage;—wherein the first storage is for storing the first intermediate count values of the first counter such that a sequence of first intermediate count values of the first counter is provided and the second storage is for storing the second intermediate count values of the second counter such that a sequence of second intermediate count values of the second counter is provided.

5. The electronic circuit according to claim 1,—wherein the calculation unit is implemented by a processor;—wherein the plurality of pairs of intermediate count values are stored in a working memory of the processor; and—wherein the working memory is accessed for one of reading and writing of the plurality of pairs of intermediate count values by interrupt routines.

6. The electronic circuit of claim 1,—wherein the calculation unit determines a variation of the frequency ratio over the time.

7. Method of determining a ratio of a first frequency of a first signal and a second frequency of a second signal, the method comprising the steps of:—sampling first intermediate count values of a first counter when a second counter reaches preset second intermediate count values such that the first counter is sampled under the control of the second counter;—wherein the first and second intermediate count values form a plurality of pairs of intermediate count values of the first and second counters;—wherein, during the sampling of the first intermediate count values, the first and second counters continue counting; and—determining the ratio of the first and second frequencies on the basis of the plurality of pairs of intermediate count values.

8. The method of claim 7,—wherein more than two pairs of intermediate count values are used for determining the ratio of the first and second frequencies.

9. Computer program product comprising computer program code means, wherein the computer program code means causes a processor to perform the following operation when the computer program code means is executed on the processor:—sampling first intermediate count values of a first counter when a second counter reaches preset second intermediate count values such that the first counter is sampled under the control of the second counter;—wherein the first and second intermediate count values form a plurality of pairs of intermediate count values of the first and second counters;—wherein, during the sampling of the first intermediate count values, the first and second counters continue counting; and—determining the ratio of the first and second frequencies on the basis of the plurality of pairs of intermediate count values.

10. The computer program product of claim 9,—wherein more than two pairs of intermediate count values are used for determining the ratio of the first and second frequencies.
